(19) United States
(12) Patent Application Publication
(10) Pub. No.: US 2003/0179569 A1
(43) Pub. Date: Sep. 25, 2003

(54) Luminescent bag apparatus

(76) Inventor: Kuo-Jung Huang, Tan Tzu Hsiang (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/102,437

(22) Filed: Mar. 21, 2002

(51) Int. Cl. F21V 21/08

(52) U.S. Cl. 362/109; 362/103; 362/84

(57) ABSTRACT

According to the present invention, the luminescent bag apparatus includes a bag and a light-emitting device attached to the bag. The light-emitting device includes a light source and a circuit for driving the light source. The light source may be a luminescent panel. The circuit may be formed as a circuit board. A switch is connected with the circuit for turning on and off the light source. In an aspect of the present invention, the light source is attached to an internal side of the bag and exposed to the exterior of the bag through a window defined in the bag. The circuit is attached to the internal side of the bag. The light source is connected with the circuit via two wires. A lining is used to cover the light source while another lining is used to cover the circuit. The linings are attached to the bag via ultrasonic adhesion. In another aspect of the present invention, the light source is attached to an external side of the bag. The circuit is attached to an internal side of the bag. The light source is connected with the circuit via two wires extending through two holes defined in the bag. The light source is attached to the bag via a hook-and-loop device. The light source includes two terminals. Each of the wires includes a terminal for engagement with one of the terminals of the light source so that the light source is connected with the circuit in a detachable manner.

### BACKGROUND OF THE INVENTION

1. Field of Invention

The present invention is related to a bag and, more particularly, to a bag with a luminescent apparatus.

2. Related Prior Art

Bags are used to carry things. Bags used to be pure tools. Therefore, they were designed and made solely to fulfill their practical functions. However, in modem societies, people not only use bags to carry things, but also to show their personalities. Therefore, bags are often provided with patterns so as to attract customers. Patterns are often provided on bags by way of adhesion, sewing, embroidering or printing.

The present invention is intended to an attractive novel bag.

### SUMMARY OF THE INVENTION

It is the primary objective of the present invention to provide a luminescent bag apparatus.

According to the present invention, the luminescent bag apparatus includes a bag and a light-emitting device attached to the bag. The light-emitting device includes a light source and a circuit for driving the light source. The light source may be a luminescent panel. The circuit may be formed as a circuit board. A switch is connected with the circuit for turning on and off the light source.

In an aspect of the present invention, the light source is attached to an internal side of the bag and exposed to the exterior of the bag through a window defined in the bag. The circuit is attached to the internal side of the bag. The light source is connected with the circuit via two wires. A lining is used to cover the light source while another lining is used to cover the circuit. The linings are attached to the bag by means of ultrasonic adhesion.

In another aspect of the present invention, the light source is attached to an external side of the bag. The circuit is attached to an internal side of the bag. The light source is connected with the circuit via two wires extending through two holes defined in the bag. The light source is attached to the bag via a hook-and-loop device. The light source includes two terminals. Each of the wires includes a terminal for engagement with one of the terminals of the light source so that the light source is connected with the circuit in a detachable manner.

### BRIEF DESCRIPTION OF DRAWINGS

The present invention is described through detailed illustration of embodiments referring to the attached drawings wherein:

FIG. 1 is a perspective view of a luminescent bag apparatus according to a first embodiment of the present invention;

FIG. 2 is an exploded view of the luminescent bag apparatus of FIG. 1;

FIG. 3 is a diagram of a circuit used in the luminescent bag apparatus of FIG. 1;

FIG. 4 is a block diagram of the circuit of FIG. 3;

FIG. 5 is a perspective view of a luminescent bag apparatus according to a second embodiment of the present invention;

FIG. 6 is an exploded view of the luminescent bag apparatus of FIG. 5;

FIG. 7 is planar view of the luminescent bag apparatus of FIG. 5;

FIG. 8 is a perspective view of a luminescent bag apparatus according to a third embodiment of the present invention; and

FIG. 9 is a perspective view of a luminescent bag apparatus according to a fourth embodiment of the present invention.

### DETAILED DESCRIPTION OF PREFERRED EMBODIMENTS

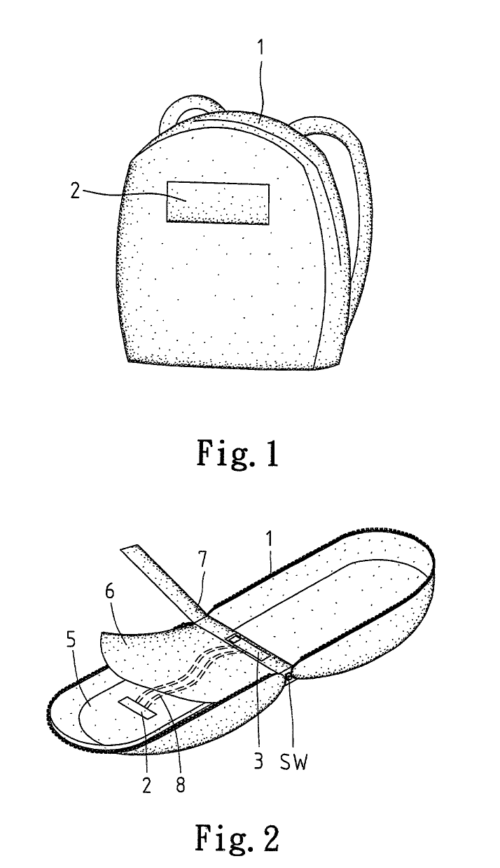

FIG. 1 shows a luminescent bag apparatus consisting of a bag 1 and a luminescent panel 2 according to a first embodiment of the present invention. The bag 1 includes a first portion (not numbered), a second portion 5 and a bottom (shown in FIG. 2 but not numbered) connecting the first portion with the second portion 5. The bag 1 is a back bag and therefore includes two straps (not numbered) attached to the first portion thereof. The straps can be rested on the shoulders of a user.

FIG. 2 shows the bag 1 opened so that its interior can be seen. The luminescent panel 2 is attached to an internal side of the second portion 5 along its edge. A major area of the luminescent panel 2 is exposed to the exterior of the bag 1 through a window defined in the second portion 5.

The luminescent panel 2 is connected with a circuit board 3 through two wires 8. The circuit board 3 is further connected with a switch SW. The circuit board 3 is mounted on an internal side of the bottom of the bag 1. The switch SW is attached to an end of the bottom of the bag 1. The luminescent panel 2 and the wires 8 are covered with a lining 6. The circuit board 3 is and is covered by means of a lining 7. The attachment of the linings 6 and 7 to the second portion 5 and the bottom respectively can be performed by means of sewing or ultra sonic wave.

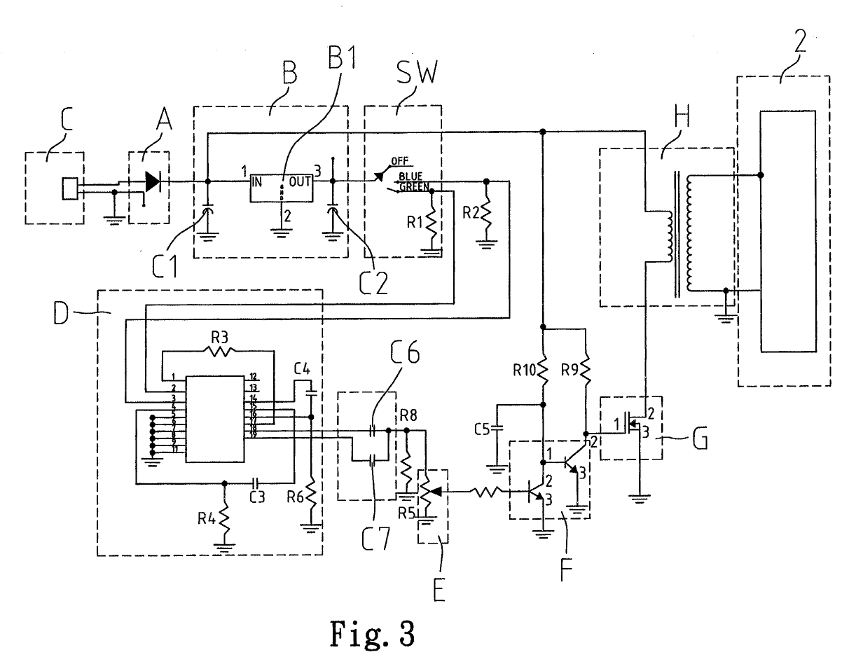

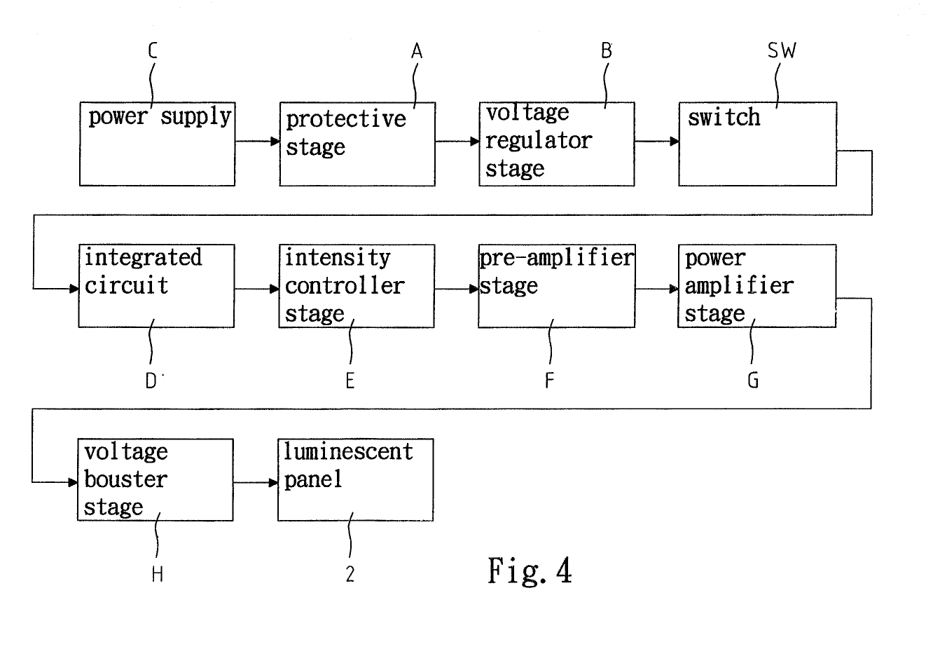

FIGS. 3 and 4 show a circuit that is implemented in the circuit board 3. The circuit includes a protective stage A, a voltage regulator stage B, the switch SW, an integrated circuit D, a intensity controller stage E, a pre-amplifier stage F, a power amplifier stage G and a voltage booster stage H.

The protective circuit stage A includes an input connected with a power supply C in order to protect the circuit from burning due to wrong connection of electrodes of the power supply C.

The voltage regulator stage B includes an input connected with the protective stage A. The voltage regulator stage B is used to regulate and, more particularly, reduce the voltage of the current provided from the power supply C, thus stabilizing the current. The voltage regulator stage B includes a capacitor C1, a capacitor C2 and a three-status voltage regulator B1 connected between the capacitors C1 and C2.

The switch SW is connected between the voltage regulator stage B and the integrated circuit D. The integrated circuit D can produce various signals different from one another in frequency. Based on each of the signals produced by means of the integrated circuit D, light of a corresponding color can be emitted from the luminescent panel 2. The switch SW can be operated so as to drive the integrated circuit D to selectively produce one of the signals. The switch SW is connected with two or three pins extending from the integrated circuit D.

Pin nos. 18 and 19 of the integrated circuit D are connected with the intensity controller stage E through two capacitors C6 and C19, respectively. The intensity controller stage E is used to control the intensity of the light to be emitted from the luminescent panel 2.

The pre-amplifier F includes an input connected with the intensity controller stage E. The signal produced by means of the integrated circuit D is amplified by means of the pre-amplifier F before it is transmitted to and amplified by means of the power amplifier G.

After amplification, the signal is transmitted to the voltage booster H wherein the signal is boosted to a high-voltage. The high-voltage signal is fed to the luminescent panel 2 so that the luminescent panel 2 is activated to emit light of a color corresponding to the signal.

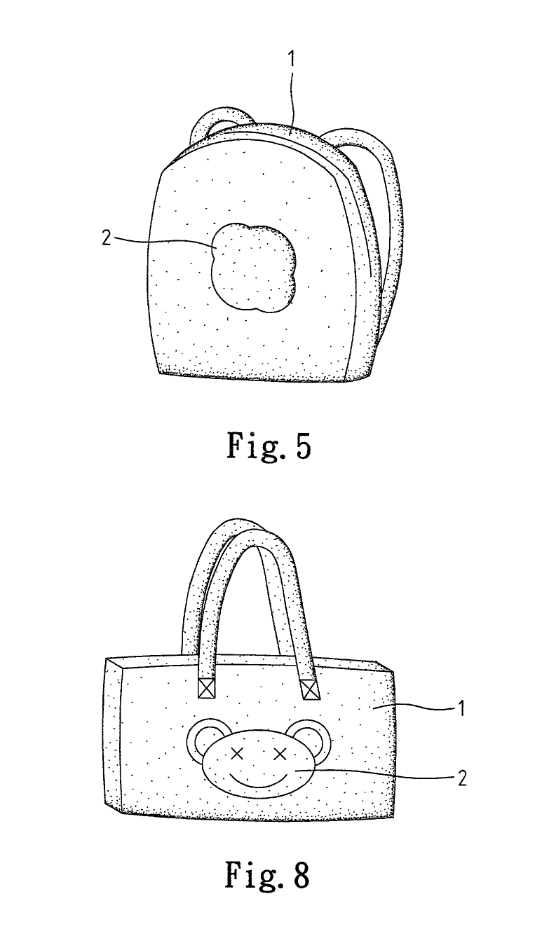

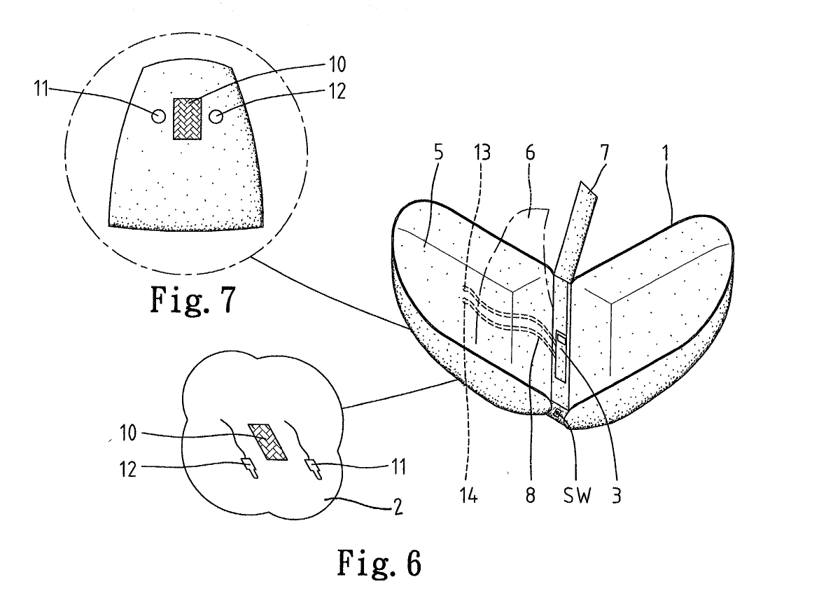

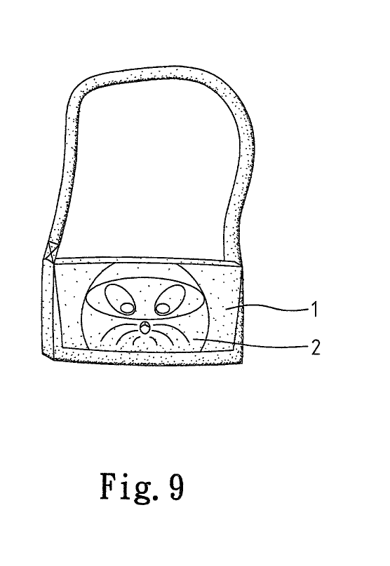

FIGS. 5 and 6 show a luminescent bag apparatus according to a second embodiment of the present invention. In the second embodiment, the luminescent panel 2 is attached to the second portion 5 of the bag 1 by means of a hook-and-loop element 10 so that they can be detached from each other. The luminescent panel 2 includes two terminals 11 and 12 each exposed to the exterior of the bag 1 as shown in FIG. 7. One of the wires 8 includes a terminal 13 for engagement with the terminal 11 while the remaining wire 8 includes a terminal 14 for engagement with the terminal 12, thus electrically connecting the luminescent panel 2. Obviously, the luminescent panel 2 can be disconnected from the wires 8 so that various luminescent panels with different patterns can be attached to the bag 1 as shown in FIGS. 8 and 9. Other features of the second embodiment are identical to that of the first embodiment.

The present invention has been described in detail for purposes of illustration. Those skilled in the art can derive a lot of variations from these embodiments after a study of this patent specification. Therefore, these embodiments shall by no means limit the scope of the present invention. The scope of the present invention can only be defined in the claims attached to and taken as a portion of this patent specification.

1. A light-emitting bag apparatus including a bag (1) and a light-emitting device attached to the bag.

2. The luminescent bag apparatus according to claim 1 wherein the light-emitting device includes a light source (2) and a circuit (3) for driving the light source (2).

3. The luminescent bag apparatus according to claim 2 wherein the light source (2) is a luminescent panel.

4. The luminescent bag apparatus according to claim 2 wherein the light source (2) is attached to an internal side of the bag (1) and exposed to the exterior of the bag (1) through a window defined in the bag (1).

5. The luminescent bag apparatus according to claim 4 wherein the circuit (3) is attached to the internal side of the bag (1).

6. The luminescent bag apparatus according to claim 5 wherein the light source (2) is connected with the circuit (3) via two wires (8).

7. The luminescent bag apparatus according to claim 6 wherein the circuit (3) is attached to an internal side of the bag (1) and the light source (2) is connected with the circuit (3) via two wires (8) extending through two holes defined in the bag (1).

8. The luminescent bag apparatus according to claim 4 including a lining (6) for covering the light source (2).

9. The luminescent bag apparatus according to claim 8 wherein the lining (6) is attached to the bag (1) by means of ultrasonic adhesion.

10. The luminescent bag apparatus according to claim 5 including a lining (7) for covering the circuit (3).

11. The luminescent bag apparatus according to claim 10 wherein the lining (7) is attached to the bag (1) by means of ultrasonic adhesion.

12. The luminescent bag apparatus according to claim 2 wherein the light source (2) is attached to an external side of the bag (1).

13. The luminescent bag apparatus according to claim 12 wherein the circuit (3) is attached to an internal side of the bag (1) and the light source (2) is connected with the circuit (3) via two wires (8) extending through two holes defined in the bag (1).

14. The luminescent bag apparatus according to claim 2 wherein the light source (2) is attached to the bag (1) in a detachable manner.

15. The luminescent bag apparatus according to claim 14 wherein the light source (2) is attached to the bag (1) by means of a hook-and-loop device.

16. The luminescent bag apparatus according to claim 14 wherein the light source (2) is connected with the circuit (3) in a detachable manner.

17. The luminescent bag apparatus according to claim 2 wherein the circuit (3) is formed as a circuit board.

18. The luminescent bag apparatus according to claim 2 including a switch (SW) connected with the circuit (3) for turning on and off the light source (2).
